(19) United States
(12) Patent Application Publication
(10) Pub. No.: US 2008/0217188 A1
(43) Pub. Date: Sep. 11, 2008

(54) LINE ARRANGEMENT IN A PLASTIC CONTAINER

(75) Inventors: Matthias Borchert, Bonn (DE); Gerd Wolter, Konigswinter (DE); Harald Lorenz, Bad Neuenahr-Ahrweiler (DE); Dirk Eulitz, Bonn (DE); Timo Kramer, Hirz-Maulsbach (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: KAUTEX TEXTRON GMBH & CO. KG, Bonn (DE)

(21) Appl. No.: 12/043,071

(22) Filed: Mar. 5, 2008

Related U.S. Application Data
(60) Provisional application No. 60/892,973, filed on Mar. 5, 2007.

(51) Int. Cl. B65D 85/00; B29C 45/14

(52) U.S. Cl. 206/6; 220/746; 137/590; 264/267

(57) ABSTRACT

The invention concerns a hollow body of plastic material, in particular a fuel tank, which was obtained by extrusion blow molding, having at least one line which is stationarily laid in its interior, wherein the hollow body is distinguished in that the line is at least region-wise joined in material bonded relationship to the inside wall of the hollow body.

### CROSS-REFERENCE TO RELATED APPLICATIONS

This application claims the benefit of U.S. Provisional Application 60/892,973 filed Mar. 5, 2007.

### FIELD

The invention concerns a line arrangement in a plastic container.

### BACKGROUND

It is known for lines and conduits which are to be stationarily laid in plastic containers to be fixed to the inside wall of the plastic container by means of clips. It is also known for snap-action receiving means for lines and conduits to be provided, which are formed in one piece, at the inside wall of the container.

In many cases plastic containers and plastic hollow bodies are produced by extrusion blow molding. In that procedure a tubular preform is extruded from an extrusion head and expanded by means of an internal increased pressure in a multi-part tool forming a mold cavity. Particularly when such containers are in the form of technical components involving complex functionalities, it is necessary for them to be provided with installation fitments which are joined together for example by means of lines and conduits. Lines and conduits for taking off fluids or for introducing fluids are also frequently to be arranged in such containers. That applies for example to fuel tanks for motor vehicles, in which venting conduits, air intake conduits, fuel conveyor lines and electric lines are to be arranged.

The position of the lines is determined in many cases by the position of functional components in the container. Fixing of the lines can be effected for example directly by way of the fixing of functional components in the container. In the production of fuel tanks it is known for example for certain functional components such as for example valves to be fixed through cut-out openings in the container wall. An expensive and complicated sealing means is required at those locations in the container. In general the operation of mounting the lines in place is effected by hand through a central aperture in the container.

In the production of hollow bodies comprising a plurality of shell portions, the arrangement of lines and conduits in the container is simpler insofar as they can be positioned and fixed prior to final assembly to constitute the closed container.

As has already been mentioned hereinbefore it is known for lines and conduits to be fixed at various locations in the container by means of holding clips provided for that purpose. The inside wall of the container can also be provided with snap-action receiving means of a slightly undercut configuration, for the lines and conduits to be pressed thereinto. The operation of fitting the lines in position can be effected during manufacture of the hollow body but also after it has been finished by hand through a maintenance opening in the container or through a large removal opening in the container.

Fixing lines in that way sometimes suffers from defects. In addition when using clips and latching connections there is always the danger that, depending on the respective purpose of use of the container, a line can subsequently come loose. That is to be avoided particularly in the case of fuel tanks as movable components in the tank cause rattling noises which basically are undesirable.

Therefore the object of the present invention is to avoid the above-described disadvantages of the state of the art.

### SUMMARY

That object is attained by a hollow body of plastic material having at least one line which is stationarily laid in its interior, which is distinguished in that the line is at least region-wise joined in material bonded relationship to the inside wall of the hollow body.

The hollow body is desirably in the form of an extrusion blow molded container, wherein the line laid therein was produced in a separate working operation.

By way of example the hollow body can be in the form of an extrusion blow molded fuel tank.

Preferably the line is welded to the inside wall of the container. The welding can be effected over the entire length of the line or however also only in portion-wise fashion.

Particularly preferably the line is of a multi-layer structure, wherein the outer layer of the line comprises a plastic material which is compatible with the inner layer of the container, in such a way that the plastic material of the outside wall of the line and the plastic material of the inside wall of the container can be welded together.

Particularly if the hollow body is in the form of an extrusion blow molded fuel tank, the wall thereof is in the form of a multi-layer co-extrudate of plastic material with barrier layers of EVOH (ethylene vinyl alcohol). The outer layer of the container generally comprises a carbon black-filled polyethylene. The inner layer of the fuel tank comprises a pure polyethylene. The barrier layer is respectively embedded in bonding agent layers. At least one layer of recycled material (‘regrind’) is provided between the outer layer of the container and the barrier layer or the bonding agent layer in question.

In the production of fuel tanks of a multi-layer wall structure in the above-described manner, openings and apertures in the container wall are to be avoided as much as possible. That problem has long been known in the state of the art. Components such as valves, valve bodies, gas-carrying lines and conduits and the like are usually not made from polyolefins or polyethylene as that material swells or is not resistant in respect of shape, in the presence of fuel. Welding such parts in the production of the fuel tank is therefore not readily possible.

In accordance with the invention it is therefore proposed that the line is co-extruded in a multi-layer configuration, wherein the sheath layer of the line is adapted for welding to the inside wall of the container. A core layer of the line can comprise for example a plastic material which is resistant in relation to hydrocarbons whereas the sheath layer comprises polyethylene. That line can be co-extruded in a multi-layer configuration, with the layers concentrically surrounding each other. In that case the sheath layer can serve exclusively for fixing the line to the inside wall of the container. The line can also be of such a configuration that it is only in region-wise or portion-wise manner that it has a sheath layer for welding to the inside wall of the container. The sheath layer serves exclusively as a welding additive or welding aid. The sheath layer can also serve as a casing layer for a plurality of line strands.

The sheath layer and the core layer of the line do not have to be connected together in material bonded relationship. If such a connection involving a material bonded relationship of the sheath layer and the core layer is wanted, that can be implemented by virtue of the above-indicated non-compatibility of the plastic materials, with the interposition of a bonding agent layer.

The invention further concerns a process for the production of a hollow body of plastic material with at least one line stationarily laid therein, wherein the hollow body is obtained by extrusion blow molding and the line is extruded in a separate working operation and the line is welded at least portion-wise to the container wall in or immediately after the operation of shaping the container.

The line can have been placed in the hollow body for example with functional components disposed thereon, during expansion of the hollow body in the tool, by means of a holder provided for that purpose. In that case the line with the components disposed thereon can have the plastic material blow molded therearound in per se known manner in the operation of shaping the hollow body.

Alternatively it is for example possible for the hollow body to be produced in a multi-stage extrusion blow molding process, wherein a three-part blow molding mold with two outer molds and a central mold are advantageously used. In that case two preforms in web form are respectively extruded between an outer mold and the central mold. The tool is closed. The preforms are respectively applied against the outer molds which define parts of the mold cavity. That is effected in known manner by differential pressure, either by virtue of the outer molds being subjected to vacuum or by the molding being subjected to a gas pressure. Component holders are arranged on the central mold, by way of which holders lines and functional components disposed thereon, if necessary, are pressed within the closed tool against the inside wall of the preform while still in a plastic condition. In that case the line can be welded to the inside wall of the container when it is not yet completely finished.

The central mold is then removed from between the outer molds. The outer molds are moved towards each other and pressed against each other in such a way that the two half-shell portions shaped therein are welded to constitute a closed container.

It will be noted that it is also possible for the container to be produced from deep-drawn or injection molded half-shell portions. Then for example the lines can be fixed in the opened half-shell portions by means of suitable welding processes.

Even if reference is made hereinbefore to a line, it will be clear to the man skilled in the art that that embraces a plurality of lines.

### DESCRIPTION OF THE DRAWINGS

The invention will be described hereinafter by means of embodiments by way of example illustrated in the drawings in which:

FIG. 1 shows a diagrammatic cross-section through a hollow body according to the invention, which is in the form of an extrusion blow molded fuel tank,

FIG. 2 shows a detail view of the detail II in FIG. 1,

FIG. 3 shows a section taken along lines III-III in FIG. 2,

FIG. 4 shows a detail view of the detail IV in FIG. 1,

FIG. 5 shows a section taken along lines V-V in FIG. 4,

FIG. 6 shows an alternative variant of the line arrangement according to the invention,

FIG. 7 shows a further variant of the line arrangement according to the invention,

FIG. 8 shows an advantageous configuration of the line arrangement according to the invention including a sheath layer and a plurality of core layers which in turn embrace a plurality of lines, and

FIG. 9 shows a further variant of the line arrangement according to the invention.

### DETAILED DESCRIPTION

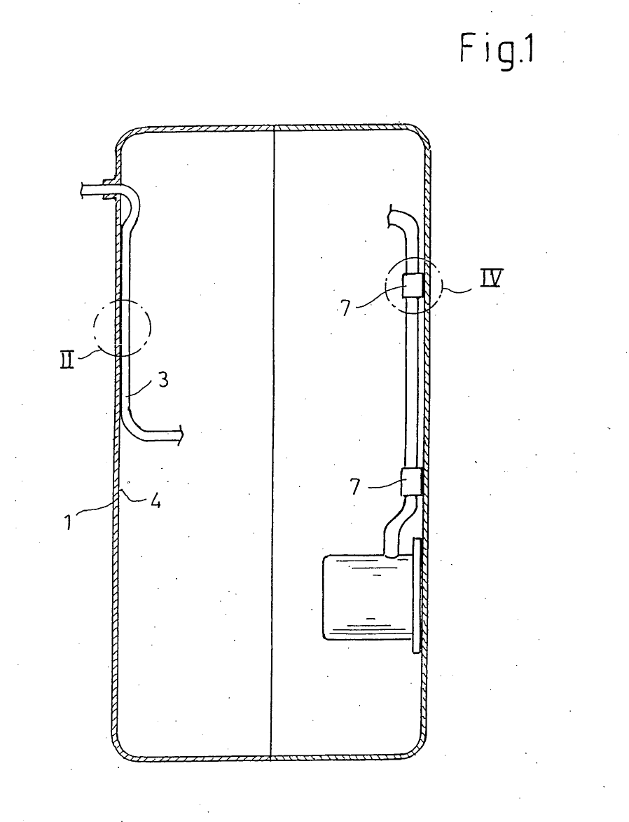

FIG. 1 shows in a diagrammatic, highly simplified view an extrusion blow molded fuel tank 1 of thermoplastic material. The fuel tank 1 in the illustrated embodiment was obtained by a multi-stage extrusion blow molding process, using a three-part blow molding tool comprising two outer molds and a central mold. In that operation two preforms in web form were respectively extruded between an outer mold and the central mold. After the tool was closed the preforms were respectively applied against the outer mold which define the parts of the mold cavity and expanded or shaped.

The fuel tank 1 comprises a co-extrudate which in total has six layers and which comprises thermoplastic material, wherein the layer structure from the outside inwardly comprises a carbon black-filled polyethylene layer, a recycled material layer, a bonding agent layer, an EVOH layer, a further bonding agent layer and a layer of pure polyethylene (virgin PE).

Arranged in the fuel tank 1 are various functional components which are required for operation in a motor vehicle. They include the surge container identified by reference 2, with the fuel delivery pump (not shown) contained therein, and a fuel removal line 3 which is passed out of the fuel tank 1. Usually a fuel tank also has a filling opening and various venting openings which are connected to venting lines (not shown). Mention should be made here by way of example of an operational venting line and a refuelling venting line which are closable with corresponding valves. The valves involved are for example roll-over valves (roll-over safeguard) and refuelling venting valves. The latter ensure closure of the refuelling venting line when a given filling level is reached. The rise in pressure in the fuel tank causes the refuelling gun valve to be switched off in the refuelling operation.

All those lines and venting points are not shown in the illustrated embodiment, for the sake of simplicity. Only the fuel removal line 3 is shown, as being representative of other lines, for example also for electric lines.

As has already been mentioned in the introductory part of this specification, various possible ways of fixing the line to the inside wall of the fuel tank are known in the state of the art. The variant which is in fact most wide-spread is fixing by means of holding clips. The holding clips are usually fixed to base members which are fixed to other functional components or however also in cut-out openings in the container wall.

In accordance with the invention it is now proposed that the lines are welded by way of partial portions thereof or also completely, to the inside wall 4 of the fuel tank 1. See FIG. 3.

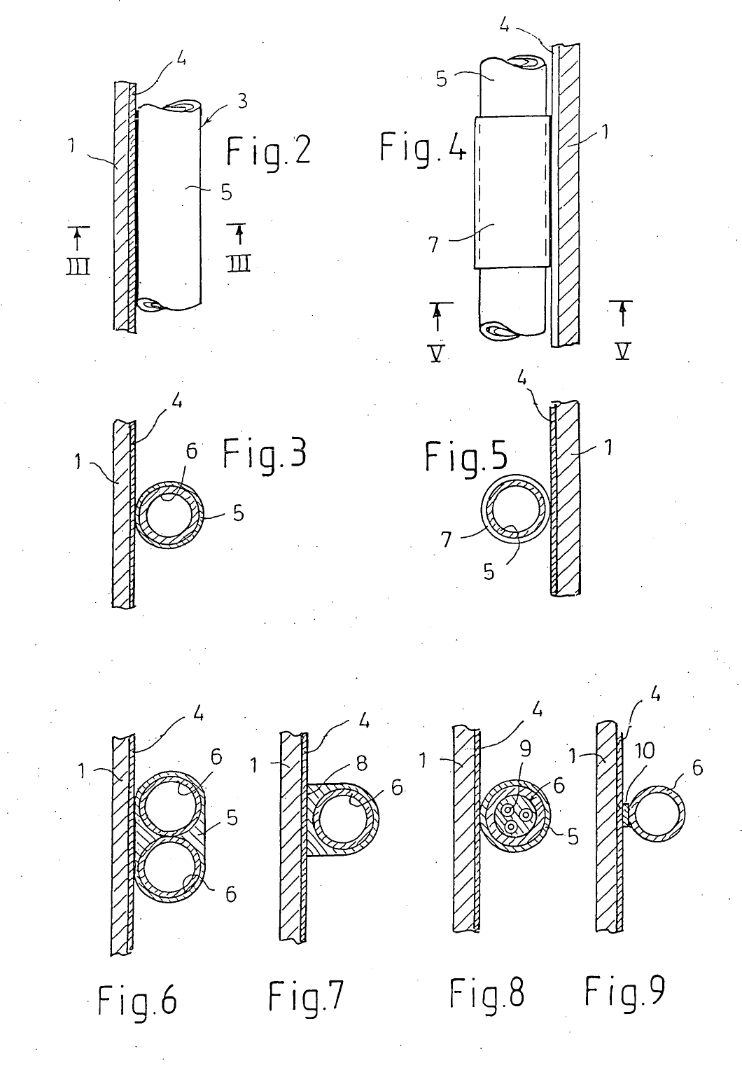

The embodiment illustrated in FIG. 1 shows in one Figure two possible variants of the manner of fixing the fuel removal line 3. The first variant is firstly described with reference to FIG. 2 (detail II in FIG. 1). The fuel removal line 3 in the variant illustrated in FIG. 2 is in the form, over its entire length, of a tube or line which is co-extruded in multi-layer configuration, wherein it includes a sheath layer 5 (outer layer) and a core layer 6 (inner layer) (See FIG. 3.) which do not necessarily have to be connected together in material bonded relationship. In the illustrated embodiment the sheath layer 5 comprises pure PE whereas the core layer 6 can comprise any material. Preferably the material used here is one which does not swell in the presence of hydrocarbons. The sheath layer 5 in the form of a PE layer is compatible with the inside wall 4 of the fuel tank 1 in the sense of weldability thereof since, as already mentioned hereinbefore, the inside wall 4 of the fuel tank 1 (See FIG. 3.) also comprises pure polyethylene. It should be observed at this juncture that, if the inside wall of the container is of a different nature, it will be appreciated that the sheath layer of the line or conduit in question must also comprise a different material which is compatible with the inside wall of the fuel tank.

In the embodiments illustrated in FIGS. 2 and 3 the line is in the form of a fuel removal line 3, that is to say it embraces a hollow space for fuel to pass therethrough.

The same applies to the fuel removal line 3 shown in FIGS. 4 and 5. It will be noted however that this is only provided in portion-wise manner with a sheath layer in the form of a cuff portion 7. The cuff portion 7 comprises a polyethylene which is weldable to the inside wall 4 of the fuel tank 1 and which like the sheath layer 5 shown in FIGS. 2 and 3 is welded in line form to the inside wall 4 of the fuel tank 1. So that the cuff portion 7 does not slip on the fuel removal line 3 upon fitment thereof in the fuel tank, it can either be of comparatively tight dimensions or it can be fixed to the fuel removal line 3 by means of a bonding agent.

FIG. 6 shows a variant of the line arrangement according to the invention, in which two core pipes 6 are embraced by a common sheath pipe 5, wherein the sheath pipe 5 is welded to the inside wall 4 of the fuel tank 1, as in the case of the embodiment shown in FIGS. 2 and 3.

The variant illustrated in FIG. 7 provides that the sheath pipe is of an asymmetrical configuration in cross-section so that in the installed position, on the side facing towards the inside wall 4 of the fuel tank 1, there is an enlarged base 8 having a comparatively large welding or joining surface area.

In the embodiment illustrated in FIG. 8 the line arrangement is of such a configuration that the core pipe 6 accommodates a line assembly 9. The line assembly 9 can comprise a plurality of fuel lines or, as in the illustrated embodiment, a plurality of electric cables which in turn are provided with a sheathing. Reference 10 denotes a filling which ensures a defined position for the lines within the line assembly 9.

Finally FIG. 9 shows a variant of the line arrangement according to the invention, in which the line is provided on one side with a bonding agent strip 11. That bonding agent strip 11 can be for example a polyolefin which is weldable to the inside wall 4. Both the bonding agent strip 11 and also the sheath layer 5 as well as the cuff portion 7 can be optimised in terms of their material nature and thickness in regard to the required thermal capacity for the purposes of weldability. According to the invention the line arrangement should be weldable to the inside wall 4 of the fuel tank 1 or another hollow body in manufacture thereof in the first heat. For that reason it is advantageous if the material provided for the welding operation has a thermal capacity which is as low as possible.

The invention has been described by way of example hereinbefore by means of a fuel tank. The invention however is not limited to the use of fuel tanks but rather other extrusion blow molded hollow bodies can be used in place of a fuel tank.

### LIST OF REFERENCES

1 fuel tank
2 surge container
3 fuel removal line
4 inside wall
5 sheath layer
6 core layer
7 cuff portion
8 base
9 line assembly
10 filling
11 bonding agent strip

1. A hollow body of plastic material having at least one line which is stationarily laid in its interior, characterised in that the line is at least region-wise joined in material bonded relationship to the inside wall of the hollow body.

2. A hollow body as set forth in claim 1 characterised in that said hollow body is in the form of an extrusion blow molded container and that the line laid therein was produced in a separate working operation.

3. A hollow body as set forth in one of claim 1 characterised in that the line is welded to the inside wall of the container.

4. A hollow body as set forth in claim 1 characterised in that the line is of a multi-layer structure, wherein the outer layer of the line comprises a plastic material compatible with the inner layer of the container in such a way that the plastic material of the outside wall of the line and the plastic material of the inside wall of the container are weldable to each other.

5. A hollow body as set forth in claim 1 characterised in that the line is co-extruded in a multi-layer configuration, the sheath layer being adapted for welding to the inside wall of the container.

6. A process for the production of a hollow body of plastic material with at least one line stationarily laid therein, wherein the hollow body is obtained by extrusion blow molding and the line is extruded in a separate working operation and the line is welded at least portion-wise to the container wall in or immediately after the operation of shaping the container.
